(19) United States
(12) Patent Application Publication
(10) Pub. No.: US 2008/0094384 A1
(43) Pub. Date: Apr. 24, 2008

(54) Driving circuit having counter and liquid crystal display employing same

(75) Inventor: Zhan-Wei Fu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZEN) CO., LTD.; INNOLUX DISPLAY CORP.

(21) Appl. No.: 11/906,408

(22) Filed: Oct. 1, 2007

(30) Foreign Application Priority Data
Sep. 29, 2006 (CN) 200610062894.2

(51) Int. Cl. G06F 3/038; G09G 3/36

(52) U.S. Cl. 345/211; 345/102

(57) ABSTRACT

An exemplary driving circuit for a liquid crystal display (3) includes a power supply circuit (34), a backlight control circuit (356) and a counter (355). The power supply circuit provides voltages for the LCD. The backlight control circuit controls whether or not the voltages provided by the power supply circuit are transferred to a backlight module of the LCD. The counter is configured for counting a number of pulses received from an external circuit, when the number of pulses received reaches a predetermined threshold number, the counter provides a trigger signal to turn on the backlight control circuit, so that the voltages provided by the power supply are transferred to the backlight module.

### FIELD OF THE INVENTION

The present invention relates to a driving circuit having a counter, and a liquid crystal display (LCD) including the driving circuit.

### GENERAL BACKGROUND

A typical LCD has the advantages of portability, low power consumption, and low radiation. LCDs have been widely used in various portable information products, such as notebooks, personal digital assistants (PDAs), video cameras and the like. Furthermore, the LCD is considered by many to have the potential to completely replace CRT (cathode ray tube) monitors and televisions.

Referring to FIG. 3, a typical LCD 1 includes a driving circuit 10, a liquid crystal panel 11, and a backlight module 12 for illuminating the liquid crystal panel 11. The driving circuit 10 provides data signals and working voltages for the liquid crystal panel 11 and the backlight module 12.

The driving circuit 10 includes a power supply circuit 14, a driving integrated circuit 15, a scan driving circuit 16, and a data driving circuit 17. The power supply circuit 14 provides voltages for the driving integrated circuit 15. The driving integrated circuit 15 drives the data driving circuit 17 and the scan driving circuit 16. The data driving circuit 17 and the scan driving circuit 16 drive the liquid crystal panel 11.

The driving integrated circuit 15 includes a scaler 151, a driving control circuit 152, a liquid crystal (LC) panel power control circuit 153, and a backlight startup circuit 154.

The power supply circuit 14 provides 5V voltages to the LC panel power control circuit 153 and the driving control circuit 152 respectively, and provides a 12V voltage to the backlight startup circuit 154. The backlight startup circuit 154 powers the backlight module 12 to light up, so that the backlight module 12 illuminates the liquid crystal panel 11.

An external circuit (not shown) such as that of a personal computer (PC) provides video signals and synchronous signals to the scaler 151. The scaler 151 processes the video signals and synchronous signals, and thereupon provides a synchronous signal to the driving control circuit 152 and data signals to the data driving circuit 17.

The driving control circuit 152 provides a clock signal and a scan signal to the data driving circuit 17 and the scan driving circuit 16 respectively.

The LC panel power control circuit 153 transforms the received 5V voltage to a high-level gate voltage (VGH), a low-level gate voltage (VGL), and an analog supply voltage (AVDD). The VGH voltage and the VGL voltage are provided to the scan driving circuit 16. The AVDD voltage is provided to the data driving circuit 17.

At the instant of starting up the LCD 1, the power supply circuit 14 provides voltages to the backlight startup circuit 154. The backlight startup circuit 154 powers the backlight module 12 to light up, and the backlight module 12 illuminates the liquid crystal panel 11. At the same time, data signals are provided to the liquid crystal panel 11. However, at this moment, the data signals are not completely stable, and typically have noise. Therefore the liquid crystal panel 11 has image signal noise, and the quality of images displayed by the liquid crystal panel 11 is impaired.

Referring to FIG. 4, another typical LCD 2 is similar to the above-described LCD 1. However, a driving integrated circuit 25 of the LCD 2 further includes a pulse width modulation circuit 256. The pulse width modulation circuit 256 is connected between a power supply circuit 24 and a backlight startup circuit 254. The pulse width modulation circuit 256 transforms a voltage provided by the power supply circuit 24 to a voltage with a needed frequency, and provides the voltage with the needed frequency to the backlight startup circuit 254. In turn, the backlight startup circuit 154 powers a backlight module 22 to light up so that the backlight module 22 illuminates a liquid crystal panel 21.

The pulse width modulation circuit 256 includes an enable end (not labeled) which is used to control a working mode of the pulse width modulation circuit 256. When the enable end receives a high voltage pulse from an external circuit such as that of the PC, the pulse width modulation circuit 256 provides voltages to the backlight startup circuit 254. When the enable end receives a low voltage pulse from the external circuit, the pulse width modulation circuit 256 is in a soft start mode, and cannot provide voltages to the backlight startup circuit 254.

A pulse width of voltages provided by the pulse width modulation circuit 256 is controlled by a scaler 251. If a frequency of pulses provided to the pulse width modulation circuit 256 from the scaler 251 is changed, the pulse width of voltages provided by the pulse width modulation circuit 256 is correspondingly changed. Thus, a brightness of the backlight module 22 can be adjusted.

At the instant of starting up the LCD 2, the power supply circuit 24 provides voltages to the pulse width modulation circuit 256, and the pulse width modulation circuit 256 provides voltages to the backlight startup circuit 254. The backlight startup circuit 254 powers the backlight module 22 to light up, and the backlight module 22 illuminates the liquid crystal panel 21. At the same time, data signals are provided to the liquid crystal panel 21. However, at this moment, the data signals are not completely stable, and typically have noise. Therefore the liquid crystal panel 21 has image signal noise, and the quality of images displayed by the liquid crystal panel 21 is impaired.

What is needed, therefore, is a driving circuit that can overcome the above-described deficiencies. What is also needed is an LCD employing such a driving circuit.

### SUMMARY

In one preferred embodiment, a driving circuit for an LCD includes a power supply circuit, a backlight control circuit and a counter. The power supply circuit provides voltages for the LCD. The backlight control circuit controls whether or not the voltages provided by the power supply circuit are transferred to a backlight module of the LCD. The counter is configured for counting a number of pulses received from an external circuit. When the number of pulses received reaches a predetermined threshold number, the counter provides a trigger signal to turn on the backlight control circuit so that the voltages provided by the power supply are transferred to the backlight module.

Other novel features and advantages will become more apparent from the following detailed description when taken in conjunction with the accompanying drawings.

### BRIEF DESCRIPTION OF THE DRAWINGS

FIG. 1 is a block diagram of a liquid crystal display (LCD) according to a first embodiment of the present invention.

FIG. 2 is a block diagram of an LCD according to a second embodiment of the present invention.

FIG. 3 is a block diagram of a conventional LCD.

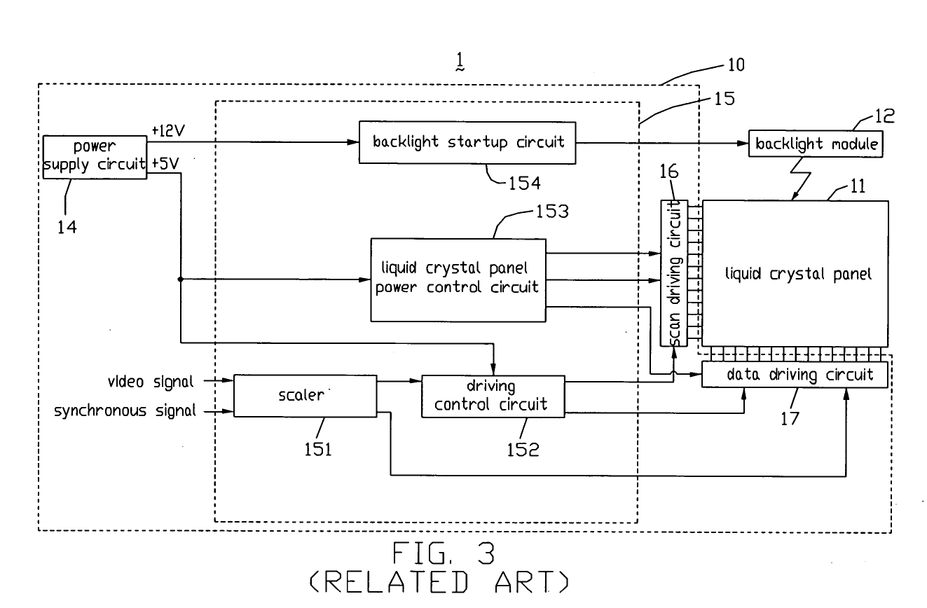

FIG. 4 is a block diagram of another conventional LCD.

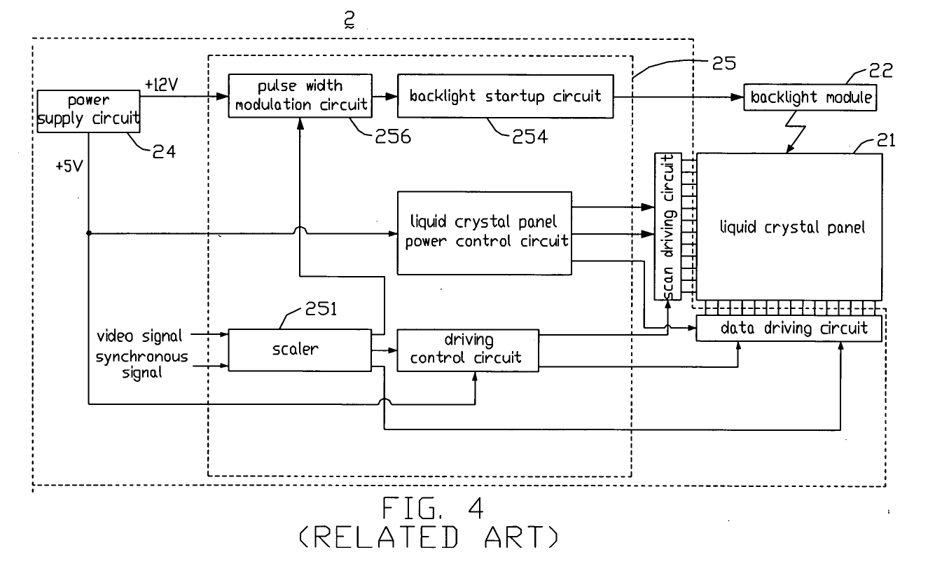

### DETAILED DESCRIPTION OF PREFERRED EMBODIMENTS

Reference will now be made to the drawing figures to describe various embodiments of the present invention in detail.

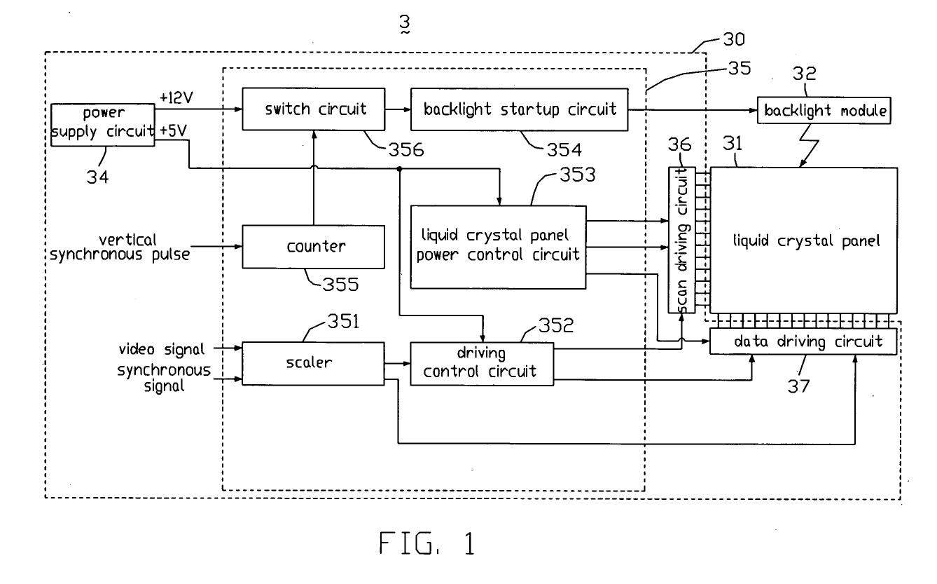

Referring to FIG. 1, an LCD 3 according to a first embodiment of the present invention includes a driving circuit 30, a liquid crystal panel 31, and a backlight module 32 for illuminating the liquid crystal panel 31. The driving circuit 30 provides data signals and working voltages for the liquid crystal panel 31 and the backlight module 32 respectively.

The driving circuit 30 includes a power supply circuit 34, a driving integrated circuit 35, a scan driving circuit 36, and a data driving circuit 37. The power supply circuit 34 provides voltages for the driving integrated circuit 35. The driving integrated circuit 35 drives the backlight module 32, the data driving circuit 37, and the scan driving circuit 36. The data driving circuit 37 and the scan driving circuit 36 drive the liquid crystal panel 31.

The driving integrated circuit 35 includes a scaler 351, a driving control circuit 352, a liquid crystal (LC) panel power control circuit 353, a backlight startup circuit 354, a counter 355, and a switch circuit 356.

The power supply circuit 34 provides 5V voltages to the LC panel power control circuit 353 and the driving control circuit 352 respectively, and provides a 12V voltage to the switch circuit 356. The backlight startup circuit 354 provides a voltage to the backlight module 32, so that the backlight module 32 lights up.

An external circuit (not shown) such as that of a personal computer (PC) provides video signals and synchronous signals to the scaler 351. The scaler 351 processes the video signals and synchronous signals, and thereupon provides a synchronous signal to the driving control circuit 352 and data signals to the data driving circuit 37. The driving control circuit 352 provides a clock signal and a scan signal to the data driving circuit 37 and the scan driving circuit 36 respectively.

The LC panel power control circuit 353 transforms the received 5V voltage to a VGH voltage, a VGL voltage, and an AVDD voltage. The VGH voltage and the VGL voltage are provided to the scan driving circuit 36. The AVDD voltage is provided to the data driving circuit 37. The backlight startup circuit 354 receives the 12V voltage from the power supply circuit 34 via the switch circuit 356, and provides a corresponding voltage to power the backlight module 32 to light up.

The switch circuit 356 has a working status of either turned on or turned off at any given time. The working status of the switch circuit 356 is controlled by the counter 355. In operation, the counter 355 receives and counts pulses such as vertical synchronous pulses from an external circuit (not shown) such as that of the PC. The counter 355 is configured with a predetermined threshold number of pulses as a reference. The threshold number of pulses is set according to technical or commercial experience or expertise, or according to the needs of customers or end users. The threshold number can be stored in a read-only memory (ROM). The ROM can be integrated with the counter 355, or integrated with the driving IC 35 and connected with the counter 355. Preferably, the ROM is integrated with the counter 355. When the counter 355 receives a total number of pulses greater than the threshold number, the counter 355 provides a trigger signal to the switch circuit 356 to turn on the switch circuit 356. A time interval during which the counter 355 receives pulses and finally reaches the threshold number is longer than a time interval from the startup of the associated external device (e.g., the PC) to a time when the liquid crystal panel 31 is capable of stably displaying images.

Because the LCD 3 includes the counter 355, when the external device (e.g., the PC) is started up, the counter 355 counts the number of pulses received from the external circuit (e.g., that of the PC). At the same time, the liquid crystal panel 31 starts to receive data signals. When the number of received pulses reaches the threshold number, the counter provides a trigger signal to turn on the switch circuit 356. Thereupon the power supply circuit 34 provides voltages to the backlight startup circuit 354 via the switch circuit 356. The backlight startup circuit powers the backlight module 32 to light up, so that the backlight module 32 illuminates the liquid crystal panel 31.

At the moment the liquid crystal panel 31 is illuminated, the data signals provided to the liquid crystal panel 31 are free of noise and stable. Therefore there is no image signal noise in the liquid crystal panel 31. Thus the quality of images displayed by the liquid crystal panel 31 is unimpaired.

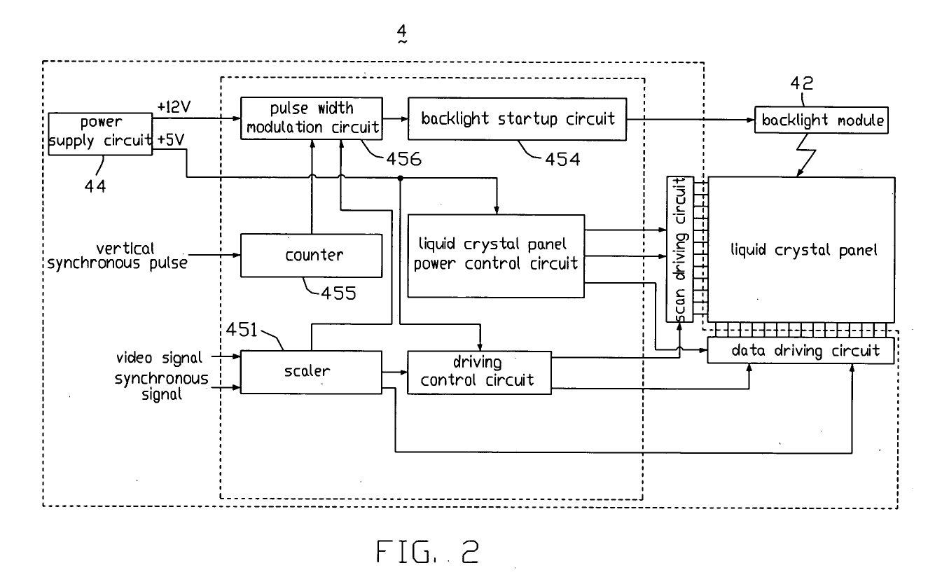

Referring to FIG. 2, an LCD 4 according to a second embodiment of the present invention is similar to the LCD 3. However, instead of there being a switch circuit 356, the LCD 4 has a pulse width modulation circuit 456. The pulse width modulation circuit 456 is connected between a power supply circuit 44 and a backlight startup circuit 454. The pulse width modulation circuit 456 has a working status of either turned on or turned off at any given time. The working status of the pulse width modulation circuit 456 is controlled by a counter 455.

When the counter 455 receives and counts a total number of pulses greater than a predetermined threshold number, the counter 455 provides a trigger signal to turn on the pulse width modulation circuit 456. The power supply circuit 44 provides voltages to the backlight startup circuit 454 via the pulse width modulation circuit 456. The backlight startup circuit powers a backlight module 42 to light up. A pulse width of the voltage provided by the pulse width modulation circuit 456 to the backlight startup circuit 454 is controlled by a scaler 451. Thus a brightness of the backlight module 42 can be adjusted. The LCD 4 has advantages similar to those described above in relation to the LCD 3.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A driving circuit for a liquid crystal display (LCD), comprising:
a power supply circuit, configured for providing voltages to the LCD;
a backlight control circuit, configured for controlling whether or not the voltages provided by the power supply circuit are transferred to a backlight module of the LCD; and
a counter configured for counting a number of pulses received from an external circuit, wherein when the number of pulses received reaches a predetermined threshold number, the counter provides a trigger signal to turn on the backlight control circuit so that the voltages provided by the power supply are transferred to the backlight module.

2. The driving circuit as claimed in claim 1, wherein the threshold number is stored in a read-only memory (ROM).

3. The driving circuit as claimed in claim 1, wherein a time interval from when the counter begins to receive pulses from the external circuit until the time when the counter reaches the threshold number is longer than a time interval from startup of an external device associated with the external circuit to a time when the LCD is capable of stably displaying images.

4. The driving circuit as claimed in claim 1, wherein the backlight control circuit comprises a switch circuit.

5. The driving circuit as claimed in claim 4, wherein the counter provides a trigger signal to the switch circuit when the number of pulses received reaches the threshold number, and the switch circuit turns on in response to the trigger signal.

6. The driving circuit as claimed in claim 1, wherein the backlight control circuit comprises a pulse width modulation circuit.

7. The driving circuit as claimed in claim 6, wherein the counter provides a trigger signal to the pulse width modulation circuit when the number of pulses received reaches the threshold number, and the pulse width modulation circuit turns on in response to the trigger signal.

8. The driving circuit as claimed in claim 1, further comprising a backlight startup circuit configured to power the backlight module to light up, wherein when the backlight control circuit is turned on, the voltages provided by the power supply circuit are transferred to the backlight module via the backlight startup circuit.

9. A liquid crystal display (LCD), comprising:
a liquid crystal panel;
a backlight module positioned for illuminating the liquid crystal panel; and
a driving circuit configured for providing voltages for the backlight module and the liquid crystal panel, the driving circuit comprising:
a power supply circuit, configured for providing voltages for the LCD;
a backlight control circuit, configured for controlling whether or not the voltages provided by the power supply are transferred to a backlight module of the LCD; and
a counter configured for counting a number of pulses received from an external circuit, wherein when the number of pulses received reaches a predetermined threshold number, the counter provides a trigger signal to turn on the backlight control circuit, so that the voltages provided by the power supply are transferred to the backlight module.

10. The LCD as claimed in claim 9, wherein the threshold number of the counter is stored in a read-only memory (ROM).

11. The LCD as claimed in claim 9, wherein a time interval from when the counter begins to receive pulses from the external circuit until the time when the counter reaches the threshold number is longer than a time interval from startup of an external device associated with the external circuit to a time when the LCD is capable of stably displaying images.

12. The LCD as claimed in claim 9, wherein the backlight control circuit comprises a switch circuit.

13. The LCD as claimed in claim 12, wherein the counter provides a trigger signal to the switch circuit when the number of pulses received reaches the threshold number, and the switch circuit turns on in response to the trigger signal.

14. The LCD as claimed in claim 9, wherein the backlight control circuit comprises a pulse width modulation circuit.

15. The LCD as claimed in claim 14, wherein the counter provides a trigger signal to the pulse width modulation circuit when the number of pulses received reaches the threshold number, and the pulse width modulation circuit turns on in response to the trigger signal.

16. The LCD as claimed in claim 9, wherein the driving circuit further comprises a backlight startup circuit configured to power the backlight module to light up, and when the backlight control circuit is turned on, the voltages provided by the power supply circuit are transferred to the backlight module via the backlight startup circuit.

17. The LCD as claimed in claim 9, wherein the driving circuit further comprises a scan driving circuit and a data driving circuit, which are configured to drive the liquid crystal panel.

18. The LCD as claimed in claim 17, wherein the driving circuit further comprises a scaler, which is configured to process video signals and synchronous pulses received from an external circuit and provide corresponding data signals to the liquid crystal panel.

19. A method of providing driving circuit for a liquid crystal display (LCD), comprising:
providing a power supply circuit configured for providing voltages to the LCD;
providing a backlight control circuit configured for controlling whether or not the voltages provided by the power supply circuit are transferred to a backlight module of the LCD; and
providing a counter configured for counting a number of pulses received from an external circuit, wherein when the number of pulses received reaches a predetermined threshold number, the counter provides a trigger signal to turn on the backlight control circuit so that the voltages provided by the power supply are transferred to the backlight module.
